(19) United States
(12) Patent Application Publication
(10) Pub. No.: US 2019/0073354 A1
(43) Pub. Date: Mar. 7, 2019

(54) TEXT SEGMENTATION

(71) Applicant: ABBYY Development LLC, Moscow (RU)

(72) Inventors: Evgenii INDENBOM, Moscow (RU); Sergey KOLOTIENKO, Rostov-na-Donu (RU)

(21) Appl. No.: 15/717,517

(22) Filed: Sep. 27, 2017

(30) Foreign Application Priority Data
Sep. 6, 2017 (RU) 2017131334

(51) Int. Cl. G06F 17/27; G06N 99/00

(52) U.S. Cl. CPC G06F 17/2785; G06F 17/2765; G06N 99/005

(57) ABSTRACT

Systems and methods for marking a natural language text to identify segments of different types. The method includes using a classification model to classify candidate segments as belonging to one of the types where the classifiers of the training model are trained on a marked natural language text.

### CROSS-REFERENCE TO RELATED APPLICATIONS

This application claims the benefit of priority to Russian Application No. 2017131334, filed Sep. 6, 2017, the disclosure of which is incorporated herein by reference in its entirety.

### TECHNICAL FIELD

The present disclosure is generally related to computer systems, and is more specifically related to systems and methods for natural language processing.

### BACKGROUND

Information extraction is one of the important operations in automated processing of natural language texts. Extracting information from natural language texts, however, can be complicated by ambiguity, which is a characteristic of natural languages. This, in turn, can require significant resources in order to extract information accurately and in a timely manner. Information extraction can be optimized by implementing extraction rules that identify specific information within those documents.

### SUMMARY OF THE DISCLOSURE

In accordance with one or more aspects of the present disclosure, an example method of marking a natural text document may comprise: performing, by a processing device, segmentation of an unmarked target text to produce a plurality of target candidate segments, wherein one or more of target candidate segments belong to one or more segment types from a plurality of segment types; identifying target text attributes within a first target candidate segment from the plurality of target candidate segments; analyzing the target text attributes from the first target candidate segment using a first segment type classifier from a plurality of segment type classifiers to categorize the first target candidate segment as having a first segment type from the plurality of segment types, wherein the first segment type classifier is trained on a marked text to categorize segments as corresponding to the first segment type; performing text analysis of the first target candidate segment based on the categorizing of the first target candidate segment as the first segment type; wherein the first segment type classifier is a one-vs-rest classifier; wherein the target candidate segments consist of one or more sentences; wherein the method further includes filtering the classified target candidate segments, and/or identifying contradictory target candidate segments, wherein the contradictory target segments are segments from the plurality of target candidate segments classified by two or more of the segment type classifiers as belonging to two or more segment types; performing semantic analysis of the contradictory sentence; and classifying the contradictory sentence as belonging to one segment type from the plurality of segment types based on the semantic analysis of the contradictory segment. In some embodiments the training of the first segment type classifier on a marked text further comprises identifying text attributes in the marked text; generating a plurality of candidate segments in the marked text; generating a first type training set for the first segment type from the plurality of candidate segments; and training the first segment type classifier on the first type training set using the text attributes in the marked text.

In accordance with one or more aspects of the present disclosure, an example system for marking a natural text document may comprise: a memory; a processing device, coupled to the memory, the processing device configured to: perform, by a processing device, segmentation of an unmarked target text to produce a plurality of target candidate segments, wherein one or more of target candidate segments belong to one or more segment types from a plurality of segment types; identify target text attributes within a first target candidate segment from the plurality of target candidate segments; analyze the target text attributes from the first target candidate segment using a first segment type classifier from a plurality of segment type classifiers to categorize the first target candidate segment as having a first segment type from the plurality of segment types, wherein the first segment type classifier is trained on a marked text to categorize segments as corresponding to the first segment type; perform text analysis of the first target candidate segment based on the categorizing of the first target candidate segment as the first segment type; wherein the first segment type classifier is a one-vs-rest classifier; wherein the target candidate segments consist of one or more sentences; wherein the method further includes filtering the classified target candidate segments, and/or identifying contradictory target candidate segments, wherein the contradictory target segments are segments from the plurality of target candidate segments classified by two or more of the segment type classifiers as belonging to two or more segment types; performing semantic analysis of the contradictory sentence; and classifying the contradictory sentence as belonging to one segment type from the plurality of segment types based on the semantic analysis of the contradictory segment. In some embodiments the training of the first segment type classifier on a marked text further comprises identifying text attributes in the marked text; generating a plurality of candidate segments in the marked text; generating a first type training set for the first segment type from the plurality of candidate segments; and training the first segment type classifier on the first type training set using the text attributes in the marked text.

In accordance with one or more aspects of the present disclosure, an example computer-readable non-transitory storage medium may comprise executable instructions that, when executed by processing device, cause the processing device to: perform, by a processing device, segmentation of an unmarked target text to produce a plurality of target candidate segments, wherein one or more of target candidate segments belong to one or more segment types from a plurality of segment types; identify target text attributes within a first target candidate segment from the plurality of target candidate segments; analyze the target text attributes from the first target candidate segment using a first segment type classifier from a plurality of segment type classifiers to categorize the first target candidate segment as having a first segment type from the plurality of segment types, wherein the first segment type classifier is trained on a marked text to categorize segments as corresponding to the first segment type; perform text analysis of the first target candidate segment based on the categorizing of the first target candidate segment as the first segment type; wherein the first segment type classifier is a one-vs-rest classifier; wherein the target candidate segments consist of one or more sentences; wherein the method further includes filtering the classified target candidate segments, and/or identifying contradictory target candidate segments, wherein the contradictory target segments are segments from the plurality of target candidate segments classified by two or more of the segment type classifiers as belonging to two or more segment types; performing semantic analysis of the contradictory sentence; and classifying the contradictory sentence as belonging to one segment type from the plurality of segment types based on the semantic analysis of the contradictory segment. In some embodiments the training of the first segment type classifier on a marked text further comprises identifying text attributes in the marked text; generating a plurality of candidate segments in the marked text; generating a first type training set for the first segment type from the plurality of candidate segments; and training the first segment type classifier on the first type training set using the text attributes in the marked text.

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1 depicts a flow diagram of one illustrative example of a method for training parameters of a classifier to identify segments of text within a document;

FIG. 2 depicts a flow diagram of one illustrative example of a method for marking an unmarked document using a classification model, in accordance with one or more aspects of the present disclosure.

FIG. 3 depicts an example of a marked natural language text

FIG. 4 depicts a diagram of an example computer system implementing the methods described herein.

### DETAILED DESCRIPTION

Described herein are methods and systems for document segmentation trained on a set of marked documents. Data extraction can be optimized by the implementation of extraction rules. This type of optimization, however, can be limited since different document segments may be associated with different rules. Thus, implementing a single set of rules across a whole document may not produce significant benefits. Similarly, implementing different sets of rules for different document segments can involve expensive operations to determine a segment type before being able to select a particular extraction rule. In some implementations, documents may include “markings” that label or otherwise identify particular segments of text within the documents for extraction. While the use of markings can reduce the amount of processing used for data extraction, identifying and marking segments within the text can often involve significant manual effort.

Aspects of the present disclosure address the above noted and other deficiencies by generating a system capable of quickly and accurately automatically marking segments within a document utilizing a training process that allows the system to generate classifiers capable of locating and marking segments of certain types within a document.

In an illustrative example, a marking system receives a natural language target document that does not include any markings. A natural language target document refers to a document that includes text content (e.g., a text document, a word processing document, an image document that has undergone optical character recognition (OCR)). The document marking system may then apply classification process to the target document to mark certain types of segments.

Classifiers used in the classification process are trained to identify document segments of a certain type. Training is performed on a marked set of documents and allows the system to quickly and efficiently identify segments of text within a document to reduce the number of production rules applied to such segment and thereby optimize the speed and quality of fact extraction from this document.

Various aspects of the above referenced methods and systems are described in details herein below by way of examples, rather than by way of limitation.

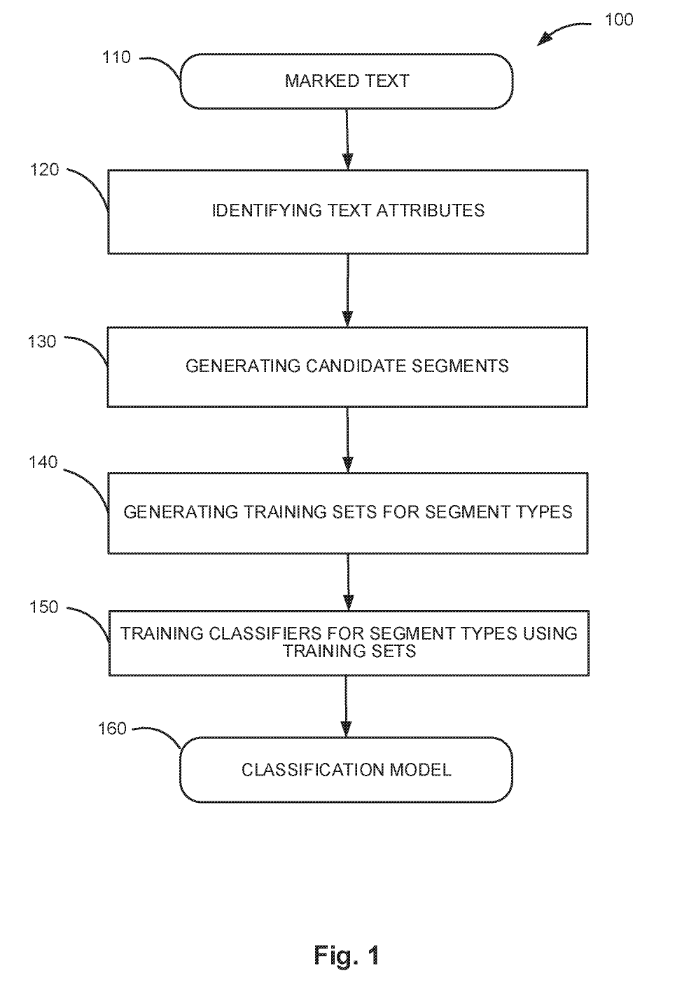

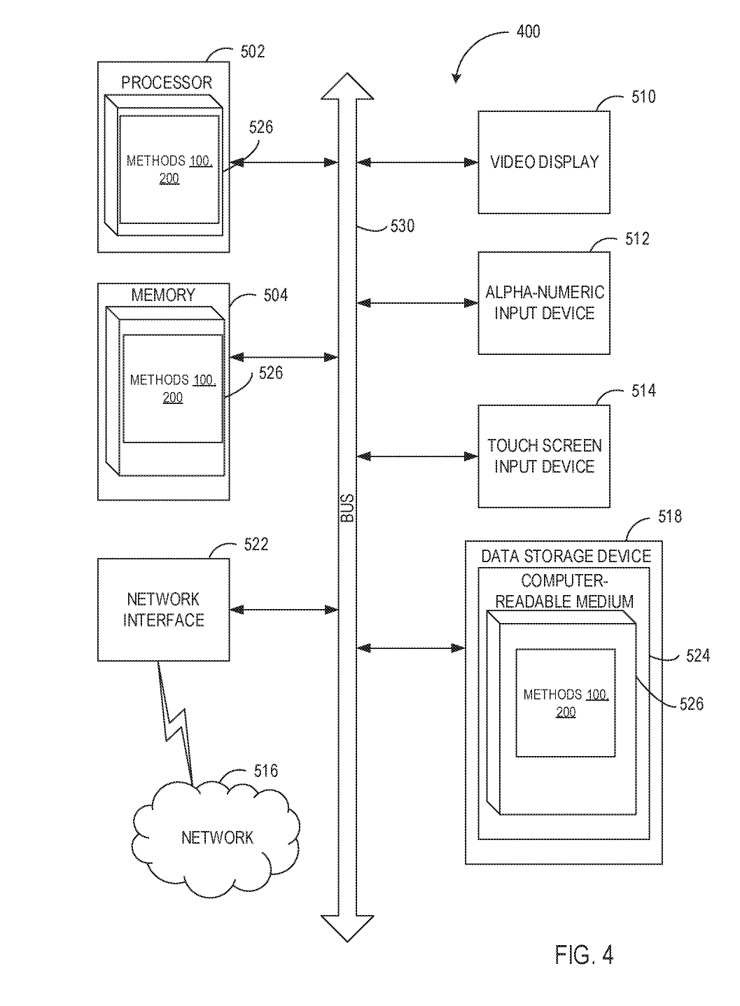

FIG. 1 depicts a flow diagram of one illustrative example of a method for training parameters of a classifier functions employed for identifying segments of text within target documents, in accordance with one or more aspects of the present disclosure. Method 100 and/or each of its individual functions, routines, subroutines, or operations may be performed by one or more processors of the computer system (e.g., computer system 400 of FIG. 4) implementing the method. In certain implementations, method 100 may be performed by a single processing thread. Alternatively, method 100 may be performed by two or more processing threads, each thread implementing one or more individual functions, routines, subroutines, or operations of the method. In an illustrative example, the processing threads implementing method 100 may be synchronized (e.g., using semaphores, critical sections, and/or other thread synchronization mechanisms). Alternatively, the processing threads implementing method 100 may be executed asynchronously with respect to each other.

At block 110, a computer system implementing the method may receive a marked natural language text 110 (e.g., a document or a collection of documents). In an illustrative example, the computer system may receive the natural language text 110 in the form of an electronic document which may be produced by scanning or otherwise acquiring an image of a paper document and performing optical character recognition (OCR) to produce the document text. In another illustrative example, the computer system may receive the natural language text 110 in the form of one or more formatted files, such as word processing files, electronic mail messages, digital content files, etc. A marked text is a text that includes marking information for marked segments. In some implementations, a segment is a portion of a text that consists of one or more full sentences, so a starting point of a segment is always a starting point of a sentence, and an ending point of a segment is always an ending point of a sentence. In some implementations a segment may span over multiple sentences and paragraphs. Each marked segment in the marked natural language text 110 is associated with one or more segment types. Segment types may include, for example, such types as “title”, “text”, “table”, “signature block”, “parties”, “contract terms”, “terms of payment”, “termination terms”, “applicable law”, etc.

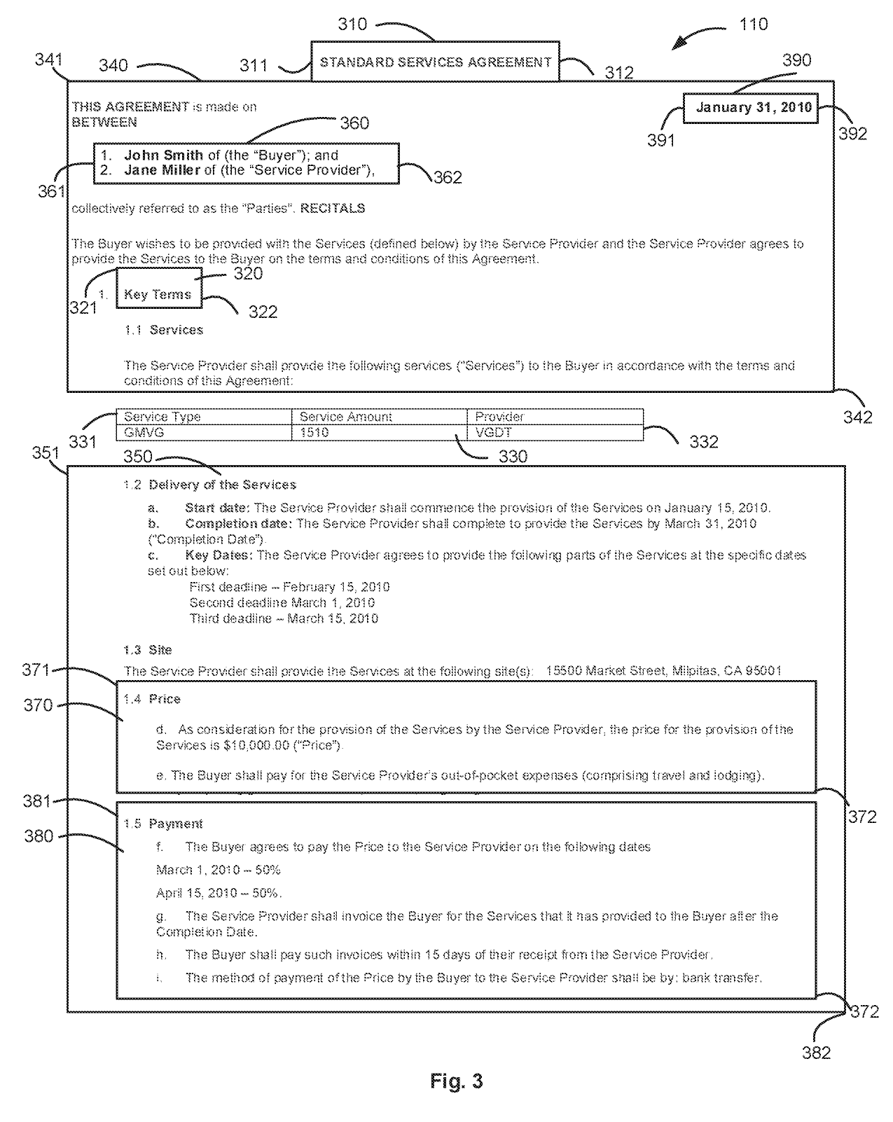

FIG. 3 depicts an example of a marked natural language text 110. This sample text 110 shows segments 310, 320, 330, 340, 350, 360, 370, 380, 390. Each segment is marked with its beginning point (311, 321, 331, 341, 351, 361, 371, 381, 391) and ending point (312, 322, 332, 342, 352, 362, 372, 382, 392). Segments 310 and 320 are segments of segment type “Title”. Segment 330 is a segment of segment type “Table”. Segments 340 and 350 mark segments of segment type “Text”. Segment 360 is a segment of segment type “Parties”. Segment 370 is a segment of segment type “Price”. Segment 380 is a segment of segment type “Payment”. Segment 390 is a segment of segment type “Date”.

In some implementations marking information for a marked segment includes information describing the segment. Such information may, in some implementations, include starting point of the marked segment, ending point of the marked segment, and segment type. In other implementations, the marking information may include starting point of the marked segment, length of the marked segment, and the segment type. In some implementations, the marked natural language text may contain multiple marked segments of the same type. However, the marked segments of the same type do not overlap. There may be parts of the marked natural language text that do not belong to any marked segment, i.e. the marked segments do not have to cover the whole text. Segment of different types can overlap. Moreover, a segment of one type can be enclosed within a segment of a different type.

At block 120, the computer system may identify text attributes for sentences of the natural language text 110. Text attributes of a sentence are text characteristics of this sentence and/or other sentences, adjoining the sentence in question. Text attributes may include inner attributes, such as a certain word is located within the sentence, or marginal attributes, such as a word or a punctuation mark located adjacent to the sentence. Position of the sentence within the text in relation to other sentences may also be one of its attributes.

At block 130, the computer system may generate a set of candidate segments for the segment types. In some implementations, the set of candidate segments is a set of all combinations of adjoining sentences in the text, including segments consisting of a single sentence, single paragraph, all combinations of 2 adjoining sentences, 3 adjoining sentences, etc.

In some implementations the system may use more discriminating criteria for generating a set of candidate segments, such as using a classifier to identify candidate beginnings and candidate ends of the candidate segments. In some implementations such classifier is trained on the received marked natural language text. In other implementations the classifier is pre-trained.

In other implementations, the system may set a limitation on the length of a candidate segment. In some implementations the maximum length of a candidate segment is predetermined. In other implementations the maximum length of a candidate segment is determined based on analysis of the received marked natural language text and of the segments marked therein.

At block 140, the computer system may generate a training set for each type of segments. In one embodiment, to generate a training set for a specified segment type, the system creates a subset of candidate segments from the set of candidate segments generated in block 130 and designates every candidate segment in the subset with either 1 or 0. The candidate segment is designated as 1, if the marked natural language text contains a marked segment of the specified type which has the same location as this candidate segment. All other candidate segments in the training set are designated as 0. In some implementations such training sets of candidate segments are created for each segment type. In some implementations the training sets are created for a specific subset of the segment types. In some implementations a user may specify for which segment types training sets are needed.

At block 150, the compute system may train one-vs.-rest classifiers for each segment type. Different models of machine learning can be used for such classifiers. In some implementations, the classifiers are a linear SVM model classifiers. In other implementations random forest type of classifiers are used. In some implementations multiple types of classifiers are used for different segment types. When training a classifier for a specific segment type, the system uses a training set, generated for this segment type in block 140 and the text attributes, identified in block 120. In some implementations all of the identified segment type attributes are used. In other implementations only segment type attributes for the sentences that are present in the corresponding training set are used in training.

The group of such trained classifiers, each corresponding to one segment type, form a classification model 160 that can be used later for marking segments in a random document.

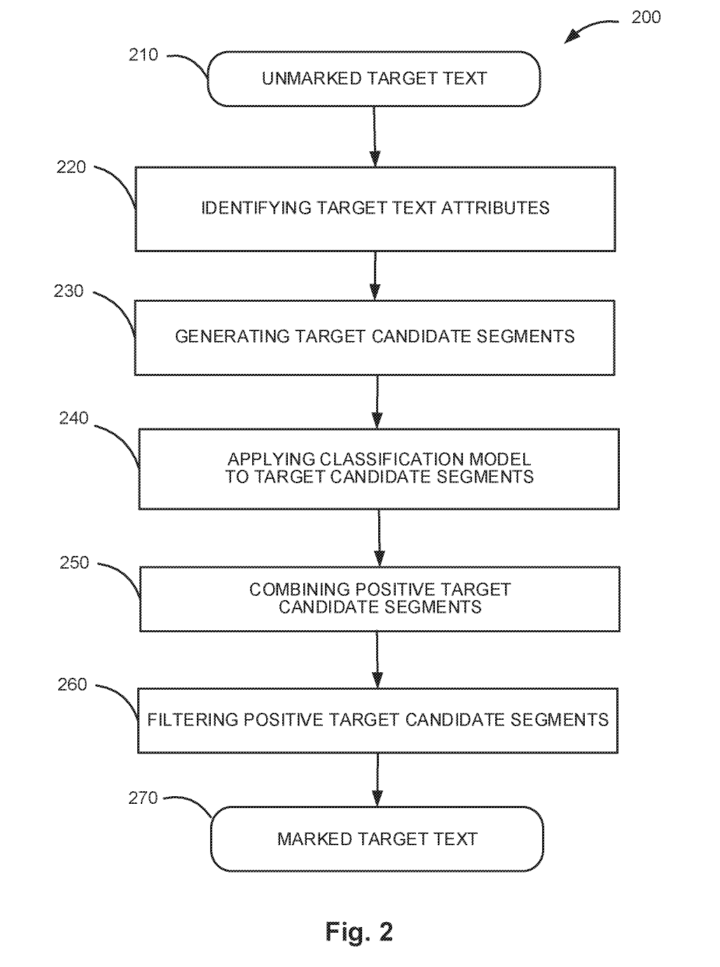

FIG. 2 illustrates how the classification model 160 may be used for marking an unmarked target text document 210.

FIG. 2 depicts a flow diagram of one illustrative example of a method for marking an unmarked document using a classification model, in accordance with one or more aspects of the present disclosure. Method 200 and/or each of its individual functions, routines, subroutines, or operations may be performed by one or more processors of the computer system (e.g., computer system 400 of FIG. 4) implementing the method. In certain implementations, method 200 may be performed by a single processing thread. Alternatively, method 200 may be performed by two or more processing threads, each thread implementing one or more individual functions, routines, subroutines, or operations of the method. In an illustrative example, the processing threads implementing method 200 may be synchronized (e.g., using semaphores, critical sections, and/or other thread synchronization mechanisms). Alternatively, the processing threads implementing method 200 may be executed asynchronously with respect to each other.

At block 210, the computer system implementing the method may receive an unmarked natural language target text 210 that according to the method 200 is marked using the classification model 160. In an illustrative example, the computer system may receive the unmarked natural language target text 210 in the form of an electronic document which may be produced by scanning or otherwise acquiring an image of a paper document and performing optical character recognition (OCR) to produce the document text. In some implementations, the target text 210 does not contain any markings, identifying marked text segments. In other implementations the target text 210 contains some segment markings that are supplemented and/or overwritten by the segment markings produced by method 200.

At block 220, the computer system may identify text attributes for some sentences of the unmarked natural language target text 210, similar to block 120. In some implementations the system may identify text attributes for each sentence of the target text 210.

At block 230 the computer system may generate a set of candidate segments for the text 210. Similar to block 130, in some implementations, the set of candidate segments is a set of all combinations of adjoining sentences in the text, including segments consisting of a single sentence, single paragraph, all combinations of 2 adjoining sentences, 3 adjoining sentences, etc. As in block 130, in some implementations, the system sets a limitation on the length of a candidate segment. In some implementations the maximum length of a candidate segment is predetermined. In other implementations the maximum length of a candidate segment is determined by other means.

At block 240, the computer system may apply the classification model 160 to the set of candidate segments, generated in block 230. In other words, the system uses classifiers, trained in block 150, to identify segments of a certain type in the set of candidate segments, generated in block 230. Each individual classifier from the model 160, corresponding to a particular segment type, sorts the candidate segments from the set of candidate segments of the unmarked target text 210. As a result, segments of that particular type are classified as positive candidate segments of this type in the set of candidate segments. Each positive candidate segment gets associated with the segment type of the classifier which identified it as positive.

In some implementations, the system applies all classifiers from the classification model 160 to the set of candidate segments. In other implementations, a subset of segment types and corresponding classifiers is chosen by the system or by a user.

At block 250, the computer system may combine all positive candidate segments of all types from all applied classifiers from block 240. In some implementations the system creates a preliminary marked natural language target text that includes segment markings for all positive candidate segments, generated by all classifiers in block 240

At block 260, the computer system may filter the combined set of segment, generated in block 250. In some implementations filtering includes combining two of more overlapping positive candidate segments of the same type to form a single segment covering all overlapping positive candidate segments. In other implementations when two or more positive candidate segments of the same type are overlapping, the segment with highest classification confidence level is chosen to remain, and the other overlapping segments are discarded.

As a result, the method 200 produces a marked target text document 270 that contains segment markings analogous to the segment markings in the marked text 110. Additionally, the markings of the marked target text 270 may contain information regarding classification confidence level for the marked segments.

In some implementations the system further processes the target text by resolving segment type inconsistencies. The system identifies contradictory segments of the target text that were identified as being of two or more different segment types. In some implementations the system resolves such ambiguity by performing semantic analysis of such segments.

In some implementations, the markings in the marked target text 270 are used during natural language processing the target text, such as data extraction, to optimize sets of extraction rules for a marked segment in accordance with segment's type.

FIG. 4 illustrates a diagram of an example computer system 400 which may execute a set of instructions for causing the computer system to perform any one or more of the methods discussed herein. The computer system may be connected to other computer system in a LAN, an intranet, an extranet, or the Internet. The computer system may operate in the capacity of a server or a client computer system in client-server network environment, or as a peer computer system in a peer-to-peer (or distributed) network environment. The computer system may be a provided by a personal computer (PC), a tablet PC, a set-top box (STB), a Personal Digital Assistant (PDA), a cellular telephone, or any computer system capable of executing a set of instructions (sequential or otherwise) that specify operations to be performed by that computer system. Further, while only a single computer system is illustrated, the term “computer system” shall also be taken to include any collection of computer systems that individually or jointly execute a set (or multiple sets) of instructions to perform any one or more of the methodologies discussed herein.

Exemplary computer system 400 includes a processor 502, a main memory 504 (e.g., read-only memory (ROM) or dynamic random access memory (DRAM)), and a data storage device 518, which communicate with each other via a bus 530.

Processor 502 may be represented by one or more general-purpose computer systems such as a microprocessor, central processing unit, or the like. More particularly, processor 502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. Processor 502 may also be one or more special-purpose computer systems such as an application specific integrated circuit (ASIC), a field programmable gate array (FPGA), a digital signal processor (DSP), network processor, or the like. Processor 502 is configured to execute instructions 526 for performing the operations and functions discussed herein.

Computer system 400 may further include a network interface device 522, a video display unit 510, a character input device 512 (e.g., a keyboard), and a touch screen input device 514.

Data storage device 518 may include a computer-readable storage medium 524 on which is stored one or more sets of instructions 526 embodying any one or more of the methodologies or functions described herein. Instructions 526 may also reside, completely or at least partially, within main memory 504 and/or within processor 502 during execution thereof by computer system 1000, main memory 504 and processor 502 also constituting computer-readable storage media. Instructions 526 may further be transmitted or received over network 516 via network interface device 522.

In certain implementations, instructions 526 may include instructions of methods 100, 400 for reconstructing textual annotations associated with information objects, in accordance with one or more aspects of the present disclosure. While computer-readable storage medium 524 is shown in the example of FIG. 20 to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and software components, or only in software.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “determining,” “computing,” “calculating,” “obtaining,” “identifying,” “modifying” or the like, refer to the actions and processes of a computer system, or similar electronic computer system, that manipulates and transforms data represented as physical (e.g., electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

It is to be understood that the above description is intended to be illustrative, and not restrictive. Various other implementations will be apparent to those of skill in the art upon reading and understanding the above description. The scope of the disclosure should, therefore, be determined with reference to the appended claims, along with the full scope of equivalents to which such claims are entitled.

What is claimed is:

1. A method, comprising:
performing, by a processing device, segmentation of an unmarked target text to produce a plurality of target candidate segments, wherein one or more of target candidate segments belong to one or more segment types from a plurality of segment types;
identifying target text attributes within a first target candidate segment from the plurality of target candidate segments;
analyzing the target text attributes from the first target candidate segment using a first segment type classifier from a plurality of segment type classifiers to categorize the first target candidate segment as having a first segment type from the plurality of segment types, wherein the first segment type classifier is trained on a marked text to categorize segments as corresponding to the first segment type;
performing text analysis of the first target candidate segment based on the categorizing of the first target candidate segment as the first segment type.

2. The method of claim 1 wherein
the first segment type classifier is a one-vs-rest classifier.

3. The method of claim 1 wherein
the target candidate segments consist of one or more sentences.

4. The method of claim 1 further comprising
filtering the classified target candidate segments.

5. The method of claim 1 further comprising
identifying contradictory target candidate segments, wherein the contradictory target segments are segments from the plurality of target candidate segments classified by two or more of the segment type classifiers as belonging to two or more segment types;
performing semantic analysis of the contradictory sentence;
classifying the contradictory sentence as belonging to one segment type from the plurality of segment types based on the semantic analysis of the contradictory segment.

6. The method of claim 1 wherein the training of the first segment type classifier on a marked text comprises
identifying text attributes in the marked text;
generating a plurality of candidate segments in the marked text;
generating a first type training set for the first segment type from the plurality of candidate segments;
training the first segment type classifier on the first type training set using the text attributes in the marked text.

7. A system, comprising:
a memory;
a processing device, coupled to the memory, the processing device configured to:
perform, by a processing device, segmentation of an unmarked target text to produce a plurality of target candidate segments, wherein one or more of target candidate segments belong to one or more segment types from a plurality of segment types;
identify target text attributes within a first target candidate segment from the plurality of target candidate segments;
analyze the target text attributes from the first target candidate segment using a first segment type classifier from a plurality of segment type classifiers to categorize the first target candidate segment as having a first segment type from the plurality of segment types, wherein the first segment type classifier is trained on a marked text to categorize segments as corresponding to the first segment type;
perform text analysis of the first target candidate segment based on the categorizing of the first target candidate segment as the first segment type.

8. The system of claim 7 wherein
the first segment type classifier is a one-vs-rest classifier.

9. The system of claim 7 wherein
the target candidate segments consist of one or more sentences.

10. The system of claim 7 further configured to filter the classified target candidate segments.

11. The system of claim 7 further configured to
identify contradictory target candidate segments, wherein the contradictory target segments are segments from the plurality of target candidate segments classified by two or more of the segment type classifiers as belonging to two or more segment types;
perform semantic analysis of the contradictory sentence;
classify the contradictory sentence as belonging to one segment type from the plurality of segment types based on the semantic analysis of the contradictory segment.

12. The system of claim 7 wherein the training of the first segment type classifier on a marked text comprises
identifying text attributes in the marked text;
generating a plurality of candidate segments in the marked text;
generating a first type training set for the first segment type from the plurality of candidate segments;
training the first segment type classifier on the first type training set using the text attributes in the marked text.

13. A computer-readable non-transitory storage medium comprising executable instructions that, when executed by a processing device, cause the processing device to:
perform segmentation of an unmarked target text to produce a plurality of target candidate segments, wherein one or more of target candidate segments belong to one or more segment types from a plurality of segment types;
identify target text attributes within a first target candidate segment from the plurality of target candidate segments;
analyze the target text attributes from the first target candidate segment using a first segment type classifier from a plurality of segment type classifiers to categorize the first target candidate segment as having a first segment type from the plurality of segment types, wherein the first segment type classifier is trained on a marked text to categorize segments as corresponding to the first segment type;
perform text analysis of the first target candidate segment based on the categorizing of the first target candidate segment as the first segment type.

14. The computer-readable non-transitory storage medium of claim 13 wherein
the first segment type classifier is a one-vs-rest classifier.

15. The computer-readable non-transitory storage medium of claim 13 wherein
the target candidate segments consist of one or more sentences.

16. The computer-readable non-transitory storage medium of claim 13 further configured to
filter the classified target candidate segments.

17. The computer-readable non-transitory storage medium of claim 13 further configured to
identify contradictory target candidate segments, wherein the contradictory target segments are segments from the plurality of target candidate segments classified by two or more of the segment type classifiers as belonging to two or more segment types;
perform semantic analysis of the contradictory sentence;
classify the contradictory sentence as belonging to one segment type from the plurality of segment types based on the semantic analysis of the contradictory segment.

18. The computer-readable non-transitory storage medium of claim 13 wherein the training of the first segment type classifier on a marked text comprises
identifying text attributes in the marked text;
generating a plurality of candidate segments in the marked text;
generating a first type training set for the first segment type from the plurality of candidate segments;
training the first segment type classifier on the first type training set using the text attributes in the marked text.
